(19) United States
(12) Patent Application Publication
(10) Pub. No.: US 2024/0152160 A1
(43) Pub. Date: May 9, 2024

(54) MAP EXPLORATION METHOD FOR EXPLORING UNKNOWN REGION BY ROBOT, CHIP, AND ROBOT

(71) Applicant: AMICRO SEMICONDUCTOR CO., LTD., Zhuhai, Guangdong (CN)

(72) Inventors: Jinjie CHEN, Zhuhai, Guangdong (CN); Huibao HUANG, Zhuhai, Guangdong (CN); Gangjun XIAO, Zhuhai, Guangdong (CN)

(21) Appl. No.: 18/280,950

(22) PCT Filed: Oct. 27, 2021
(86) PCT No.: PCT/CN2021/126773

§ 371 Date: Sep. 8, 2023

(30) Foreign Application Priority Data
Mar. 11, 2021 (CN) 202110264567.X

(51) Int. Cl. G05D 1/648; G01C 21/00; G01C 21/20; G05D 1/246

(52) U.S. Cl. CPC G05D 1/648; G01C 21/206; G01C 21/383; G05D 1/246; G05D 2105/87

(57) ABSTRACT

Disclosed are a map exploration method for exploring an unknown region by a robot, a chip, and the robot. The map exploration method includes: step S1: acquiring frontier points that meet a preset passing condition by means of a frontier detector based on a rapid exploration random tree algorithm; step S2: filtering out frontier points for exploring the unknown region among the frontier points acquired in step S1; step S3: on the basis of navigation costs of frontier points explored by the robot at a current position and income information corresponding to the navigation costs, and by considering a passable condition of the frontier points, selecting a frontier point with the highest revenue from the frontier points filtered out in step S2, configuring the frontier point as a target point, and then controlling the robot to move from the current position to the target point, thereby building a local map.

### CROSS-REFERENCE TO RELATED APPLICATION

The present disclosure claims the priority of Chinese patent application No. 202110264567.X, filed with China National Intellectual Property Administration on Mar. 11, 2021 and entitled “MAP EXPLORATION METHOD FOR EXPLORING UNKNOWN REGION BY ROBOT, CHIP, AND ROBOT”, the entire contents of which are incorporated herein by reference.

### TECHNICAL FIELD

The present disclosure relates to the technical field of map exploration by robots, and relates to a map exploration method for exploring an unknown region by a robot, a chip, and the robot.

### BACKGROUND

Intelligent mobile robots are still the hot spot of research and market at home and abroad, and many of technologies related to mobile robots are centered on maps. There are a lot of ways to acquire maps. However, map building on a sweeping robot is gradually performed in the sweeping process, and such a map building method is not applicable to a scene where a robot needs to rapidly acquire a map of an unknown region, which affects the navigation efficiency of the robot.

In the Chinese patent CN110221614A, after frontier points detected by a frontier detector are filtered through a filter, a frontier point with the highest revenue is allocated to a robot through a market economy-based multi-robot task allocation strategy in order to build a local map, and then map information obtained by a plurality of robots is shared and fused to obtain a final map. This patent is applicable to solving the problem of delay of information interaction between the plurality of robots in the same working environment, making the patent consume assignment instructions with a large amount of calculation and not consider the accessibility of a map building region of the robot.

### SUMMARY

The technical solutions of the present disclosure disclose an RRT algorithm-based improved map exploration method for exploring an unknown region by a robot. The specific technical solutions are as follows: A map exploration method for exploring an unknown region by a robot includes: step 1: frontier points that meet a preset passing condition are acquired by means of a frontier detector based on a rapid exploration random tree algorithm; step 2: exploration repeatability of frontier points for exploring the unknown region by the robot among the frontier points acquired in step 1 is checked, and frontier points that do not meet the exploration repeatability are stored into a frontier point list according to a check result; and step 3: on the basis of navigation costs of the frontier points and income information corresponding to the navigation costs, and by considering a passable condition of the frontier points, a frontier point with the highest revenue is selected from the frontier points stored in the frontier point list, and configured as a target point, and then the robot is controlled to move from a current position to the target point, thereby guiding the robot to build a map within the unknown region.

In some embodiments, step 1 specifically includes: step 11: a first random node is randomly explored within a pre-built map region based on a random tree constructed by the frontier detector, and then step 12 is performed; step 12: a container is searched for a reference frontier point closest to the first random node, and then step 13 is performed, wherein the container is a memory space set up within the robot to support continuous storage of data information, the container stores grid information of preset frontier points, and the grid information includes position information and grid state information; step 13: on a half-line from the reference frontier point towards the first random node, an exploration node that is one preset detection radius away from the reference frontier point is searched for, and then step 14 is performed, wherein the preset detection radius is detection distance information configured by the frontier detector; and step 14: the frontier detector is controlled to check a line segment between the exploration node and the reference frontier point and acquire the frontier points that meet the preset passing condition.

In some embodiments, the checking a line segment between the exploration node and the reference frontier point and acquiring the frontier points that have a safe passing effect meeting the preset passing condition specifically includes the following steps: under the condition that the frontier detector checks that grids through which the line segment between the exploration node and the reference frontier point penetrates are all grids marked with a free state, position information of grids marked with the free state on the line segment except for the reference frontier point is stored into the container, and all grids marked with the free state on the line segment except for the reference frontier point are acquired and determined as frontier points marked with a free state that have a safe passing effect meeting the preset passing condition, thereby obtaining grid information of newly set frontier points in the container, wherein the grids through which the line segment between the exploration node and the reference frontier point penetrates further include a grid corresponding to the exploration node and a grid corresponding to the reference frontier point; and wherein each of the frontier points has a corresponding grid.

In some embodiments, the checking a line segment between the exploration node and the reference frontier point and acquiring the frontier points that have a safe passing effect meeting the preset passing condition specifically further includes the following steps: in a process that the frontier detector checks grids through which the line segment between the exploration node and the reference frontier point penetrates one by one, under the condition that a grid marked with an occupied state is detected out, the grid marked with the occupied state is not processed, and then step 11 is performed again; under the condition that a grid marked with an unknown state is detected out, whether a grid marked with an occupied state exists within a circular region with the grid marked with the unknown state as a center of the circle and having a radius of one body passable distance continues to be checked; if the grid marked with the occupied state exists within the circular region, the grid marked with the unknown state is not processed, and then step 11 is performed again; if the grid marked with the occupied state does not exist within the circular region, the grid marked with the unknown state is configured as a frontier point for exploring the unknown region by the robot, the grid marked with the unknown state is acquired and determined as a frontier point marked with an unknown state that has a safe passing effect meeting the preset passing condition, and meanwhile, position information of the grid marked with the unknown state is added into the filter until step 3 starts to be performed, wherein the body passable distance is set to be greater than a body width of the robot but smaller than twice the body width; and wherein the filter is a functional module disposed inside the robot for checking the exploration repeatability of the frontier points and selecting, from the frontier points stored in the frontier point list, an actual position that is reachable for the robot to navigate to.

In some embodiments, the frontier detector includes a local detector and a global detector, so that the random tree constructed by the frontier detector includes a local random tree and a global random tree; and the preset detection radius includes a first preset detection radius and a second preset detection radius, wherein the local detector is configured to explore frontier points within the first preset detection radius from the current position of the robot by constructing the local random tree, and to control the local random tree to reset whenever a grid marked with an unknown state is detected out, so that the frontier detector may explore details of near-range places more easily, for example, some corners; the global detector is configured to explore frontier points within the second preset detection radius from the current position of the robot by constructing the global random tree, but never control the global random tree to reset, so that the global detector may explore long-range places more easily. It is to be noted that the first preset detection radius is smaller than the second preset detection radius, and the first preset detection radius and the second preset detection radius are of different orders of magnitude, and both have an overlapping region with a sensing range of the sensor.

In some embodiments, step 2 specifically includes: under the condition that frontier points received by the filter are only within effective ranges of frontier points stored in a frontier point seed list, it is determined that the frontier points received by the filter are repeatedly explored frontier points, the frontier points received by the filter are not stored into the frontier point seed list, and meanwhile, in the frontier point seed list, frontier points corresponding to the effective ranges where the repeatedly explored frontier points fall are counted and marked until step 3 starts to be performed, wherein each of the frontier points stored in the frontier point seed list has a matching effective range to represent an explored region of the robot; under the condition that the frontier points received by the filter are within effective ranges of frontier points stored in a frontier point fruit list, it is determined that the frontier points received by the filter are repeatedly explored frontier points, and the frontier points received by the filter are not stored into the frontier point seed list; and under the condition that the frontier points received by the filter are not within the effective ranges of the frontier points stored in the frontier point list, it is determined that the frontier points received by the filter do not meet the exploration repeatability, and the frontier points received by the filter are stored into the frontier point seed list until step 3 starts to be performed, wherein the effective range of each of the frontier points stored in the frontier point list represents a circular region with the frontier point stored in the frontier point list as a center of the circle and having a first effective detection radius, and belongs to explored nodes of the robot; the first effective detection radius is smaller than or equal to a sensing radius of a sensor used by the robot to scan an environment; and wherein the frontier point list includes the frontier point seed list and the frontier point fruit list.

In some embodiments, step 3 includes: on the basis of the navigation costs of the frontier points and the income information corresponding to the navigation costs, and by considering the passable condition of the frontier points, the filter is controlled to select the frontier point with the highest revenue from the frontier points stored in the frontier point seed list, the frontier point is configured as the target point, and then the frontier point is stored into the frontier point fruit list.

In some embodiments, step 3 further includes: after selecting the frontier point with the highest revenue from the frontier points in the frontier point seed list and adding the frontier point into the frontier point fruit list, based on a count value of the frontier points in the frontier point seed list obtained in step 2, a target point with the greatest count value is selected from target points with the same revenue stored in the frontier point fruit list, and assigned to the robot, and then the robot is controlled to move from the current position to the target point with the greatest count value, thereby guiding the robot to build a local map within the unknown region.

In some embodiments, in step 3, a method for selecting the frontier point with the highest revenue from the frontier points stored into the frontier point seed list and adding the frontier point into the frontier point fruit list specifically includes: revenues of the frontier points stored in the frontier point seed list are calculated respectively, and then the revenues of the frontier points stored in the frontier point seed list are sorted by numerical size; whether a grid marked with an occupied state exists within the circular region with the corresponding frontier point as a center of the circle and having the radius of one body passable distance is sequentially determined in an order of revenue from large to small; if the grid marked with the occupied state exists within the circular region, it is determined that the corresponding frontier point does not meet the passable condition, the corresponding frontier point is deleted from the frontier point seed list, and the determining step is repeatedly performed to determine a frontier point with a second greatest revenue; if the grid marked with the occupied state does not exist within the circular region, it is determined that the corresponding frontier point meets the passable condition, meanwhile, the corresponding frontier point, that is, the frontier point with the highest revenue, is stored into the frontier point fruit list, and the frontier point is configured as the target point, so as to connect the unknown region with the explored region.

In some embodiments, a method for calculating the revenues of the frontier points stored in the frontier point seed list includes: the revenue corresponding to each of the frontier points stored in the frontier point seed list is equal to a difference obtained by subtracting the navigation cost from a product of an adjustable parameter and the income information, wherein the adjustable parameter is a positive constant parameter for allowing the robot to explore a relatively large unknown region with a relatively small navigation cost by increasing the income information; and wherein the navigation cost is a straight-line distance between the current position of the robot and one frontier point currently involved in calculation stored in the frontier point seed list; accordingly, the income information is an area of an unknown region in a circle with the frontier point currently involved in the calculation stored in the frontier point seed list as a center of the circle and having a second effective detection radius; and the second effective detection radius is smaller than or equal to the sensing radius of the sensor used by the robot to scan the environment.

A chip is provided. The chip is configured to store a program. The program is configured to perform the map exploration method for exploring the unknown region by the robot.

A robot is provided. A sensor for scanning an environment is assembled on a body surface of the robot. The chip is disposed inside the robot and configured to perform the map exploration method for exploring the unknown region by the robot.

### BRIEF DESCRIPTION OF THE DRAWINGS

FIG. 1a is a schematic diagram of a robot exploring a frontier point A by using a frontier detector and a filter from an initial position within a known map region.

FIG. 1b is a schematic diagram of the robot exploring a frontier point B and other frontier points added to a frontier point seed list by using the frontier detector and the filter after moving to the frontier point A in FIG. 1a, where a white region denotes an explored region of the robot, a slash-filled region denotes an unknown region, the robot is denoted by a white circle in the figure, and the frontier points explored by the robot are denoted by solid black circles.

FIG. 2a is a schematic diagram of moving to the frontier point B according to a frontier point filtering result and exploring frontier points C and D and other frontier points configured to be added to the frontier point seed list by using the frontier detector and the filter on the basis of the map region explored by the robot in FIG. 1b.

FIG. 2b is a schematic diagram of the robot moving to the frontier point C and exploring associated frontier points according to a frontier point filtering result on the basis of the map region explored by the robot in FIG. 2a.

FIG. 2c is a schematic diagram of the robot moving to the frontier point D according to a frontier point filtering result and exploring frontier points newly added to the frontier point seed list by using the frontier detector and the filter on the basis of the map region explored by the robot in FIG. 2b.

FIG. 3 is a flow diagram of a map exploration method for exploring an unknown region by a robot according to an embodiment.

FIG. 4 is a flow diagram of specific operations of step S1 in FIG. 3.

FIG. 5 is a flow diagram of specific operations of step S2 in FIG. 3.

### DETAILED DESCRIPTION OF THE EMBODIMENTS

Specific implementations of the present disclosure are further described below in conjunction with the accompanying drawings. It should be noted that the detailed descriptions below are illustrative and are intended to provide a further description of the present application. Unless otherwise indicated, all technical and scientific terms used herein have the same meaning as would normally be understood by a person of ordinary skill in the technical art to which the present application belongs.

It is to be noted that the terms used here are intended only to describe the specific implementations and are not intended to limit exemplary implementations according to the present application. As used here, the singular form is also intended to include the plural form unless the context expressly indicates otherwise, and it should also be understood that when the terms “include” and/or “comprise” are used in this specification, they indicate the presence of features, steps, operations, devices, components, and/or combinations thereof.

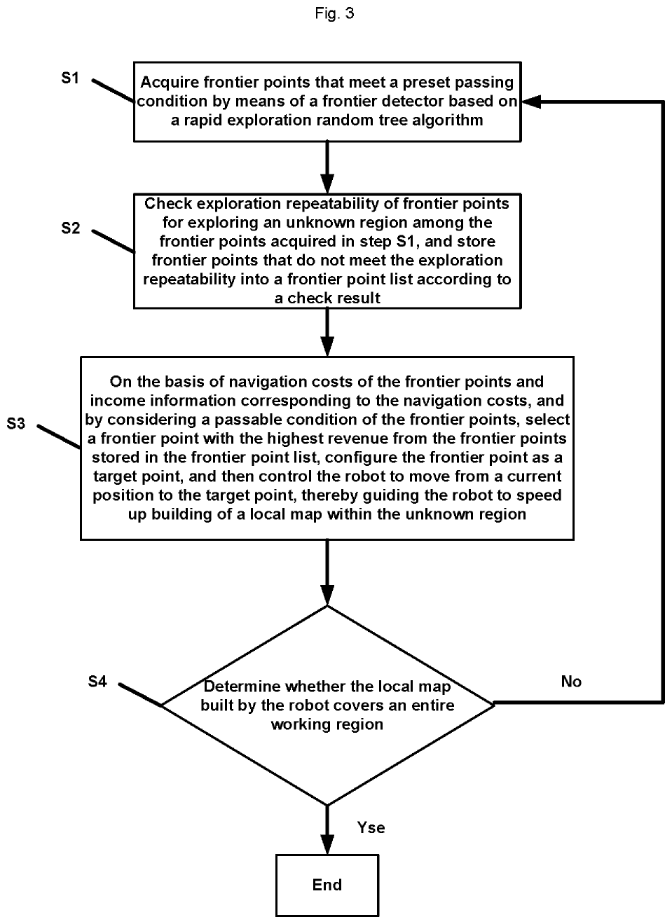

Referring to FIG. 3, an embodiment of the present disclosure discloses a map exploration method for exploring an unknown region by a robot. The map exploration method includes: Step S1: frontier points that meet a preset passing condition are acquired by means of a frontier detector based on a rapid exploration random tree algorithm; and then step S2 is performed. The frontier detector provided in step S1 is responsible for detecting frontier points near the robot that meet the preset passing condition. The frontier points that meet the preset passing condition are associated position points that are searched out based on random expansion of an RRT random tree for guiding the robot to keep away from obstacles and determined based on grid state information detected by the frontier detector on a map built by the robot, so that the robot may avoid colliding with the obstacles when navigated to the frontier points subsequently, and collisions of the robot with the obstacles are avoided. In this embodiment, the frontier points that meet the preset passing condition specifically include frontier points marked with a free state that meet the preset passing condition, and frontier points marked with an unknown state that meet the preset passing condition. The above frontier points are marked with three states: free, occupied, and unknown, within a map region. It is to be noted that the frontier detector is a software functional module, a hardware functional module and/or a combination thereof configured by the robot for the rapid exploration random tree algorithm.

Step S2: Exploration repeatability of frontier points for exploring the unknown region by the robot among the frontier points acquired in step S1 is checked, frontier points that do not meet the exploration repeatability are stored into a frontier point list according to a check result, and then step S3 is performed. The frontier points acquired in step S1 include frontier points to be filtered and frontier points not subject to filtering, which may exist in both an explored region and the unknown region, but both meet the preset passing condition. The frontier points to be filtered include points belonging to the unknown region, and are assigned to the robot for exploring the unknown region in step S3 after being filtered by a filter under the same algorithm framework. The frontier points not subject to filtering are stored for assisting in determination of the preset passing conditions in step S1 in order to acquire more frontier points to be filtered. Thus, step S2 is performed to check the exploration repeatability of the frontier points to be filtered, thereby removing repeatedly visited frontier points, reducing redundant and repeated frontier points generated in the exploration process of the robot, and improving the exploration efficiency of the robot. It is to be noted that the robot does not move in step S1 and step S2.

Step S3: On the basis of navigation costs of the frontier points and income information corresponding to the navigation costs, and by considering a passable condition of the frontier points, a frontier point with the highest revenue is selected from the frontier points stored in the frontier point list, and configured as a target point, and then the robot is controlled to move from a current position to the target point, thereby guiding the robot to speed up building of a local map within the unknown region. Step S4 is then performed. The revenue is calculated based on a difference between the income information of each frontier point (not necessarily a single frontier point) explored by the robot at the current position and the navigation cost corresponding to the income information. A revenue value is biased towards the weight of the income information, thereby guiding the robot to explore a relatively large unknown region with a relatively small navigation cost.

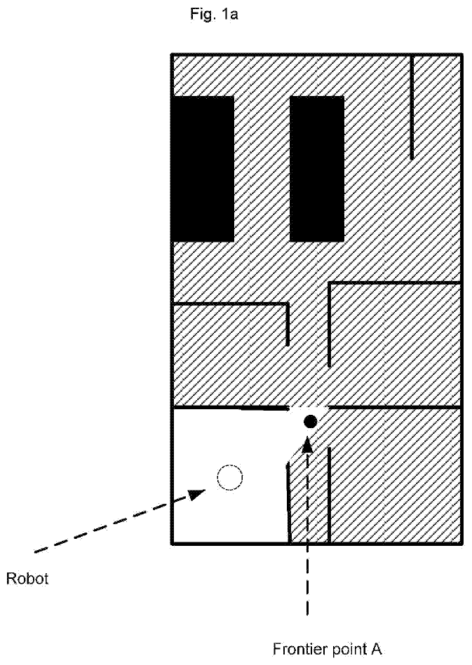

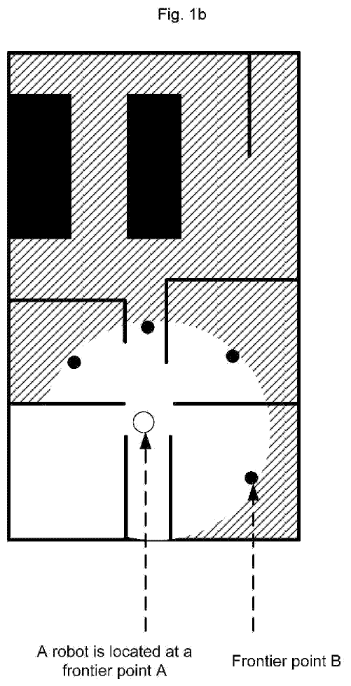

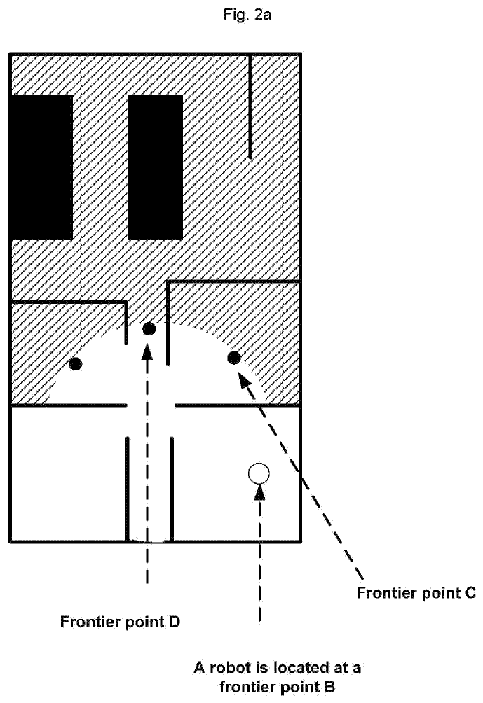

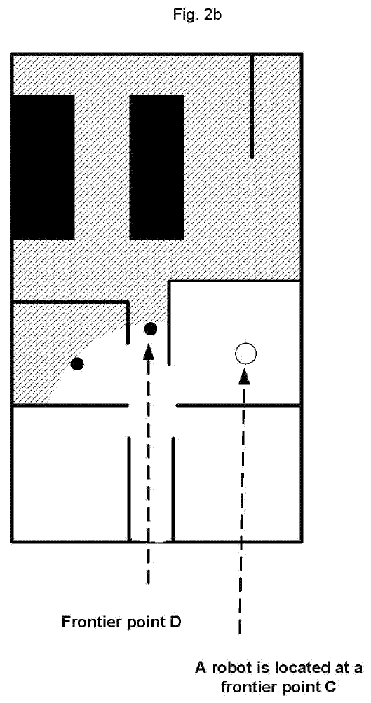

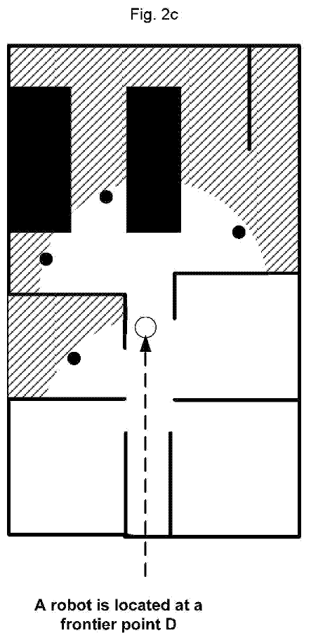

Step S4: Whether the local map built by the robot covers an entire working region is determined. If yes, a current map exploration task of the robot is ended, otherwise, step S1 is performed again. The entire working region includes a known region and the unknown region within a room region where the robot is located. As shown in FIG. 1 and FIG. 2, a white region in the figures denotes an explored region of the robot, and a splash-filled region denotes the unknown region. The robot may finally build a global map within the room region shown in FIG. 2, so that all regions except obstacles are marked as the known region. The frontier points (solid black circles) in the figures are all searched out after the robot builds the map. A small map as the white region in the figures is built before the robot starts exploration, and then the map build by the exploration of the robot increases with the increase of an effective coverage region of the solid black circles explored by the robot. The white region in the figures is a map built during the exploration, and the next exploration action is based on the white region built in the figures.

In the above steps, during the exploration for the unknown environment by relying on nodes expanded by the RRT random tree, the robot moves in the environment step by step and senses the environment through one or more sensors, and sensed sensor information is used for building an environment map. As the selection of target points determines an exploration position and exploration order of the robot, it is very important to select appropriate target points for the robot to improve the exploration efficiency. In addition, avoidance of traffic obstacles such as collisions should also be considered in the exploration process.

It is to be noted that the frontier points in the present disclosure are understood as nodes on the map, path nodes, or tree nodes grown by the random tree, which are endowed with the node meaning in the corresponding scene in the specific exploration step and may be represented by grids of corresponding attributes.

Compared with the Chinese patent CN110221614A disclosed in the prior art, in this embodiment, the frontier points that meet the preset passing condition are explored in a detection link of the frontier detector, so as to keep the robot away from obstacles during subsequent traversing of the frontier points. In this technical solution, in the step of filtering the frontier points, the frontier points for exploring the unknown region are detected and screened to acquire the frontier point with the highest revenue and having a surrounding region meeting the preset passing condition, and then the frontier point is configured as the target point. Compared with frontier point clustering filtering and multi-task assignment exploration path methods in the prior art, the amount of calculation is greatly saved, an efficient RRT map exploration algorithm is formed, and the advantages of low amount of calculation and rapidness are achieved.

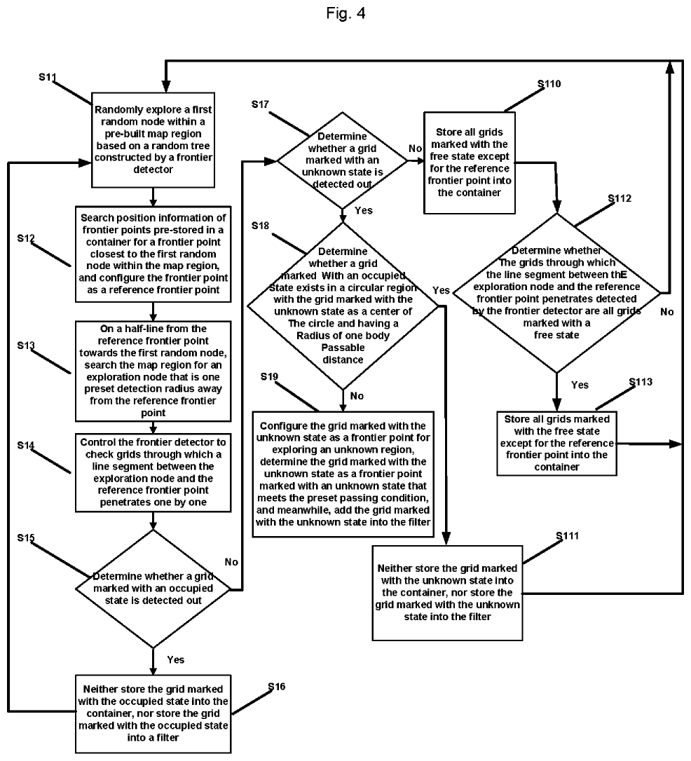

As an embodiment, as shown in FIG. 4, step S1 specifically includes: Step S11: A first random node is randomly explored within a pre-built map region based on a random tree constructed by the frontier detector, and then step S12 is performed. In step S11, the RRT-based frontier point detector, including a global frontier detector and a local frontier detector, is used for detecting frontier points. The essence of the frontier detector here is to construct a random tree that searches a map space by randomly growing nodes and preferentially extends to the unknown region, but does not depend on movement of the robot.

Step S12: Based on position information of the frontier points, the position information of the frontier points pre-stored in a container is searched for a frontier point closest to the first random node within the map region, the frontier point is configured as a reference frontier point, and then step S13 is performed. The container is a memory space set up within the robot to support continuous storage of data information. The container stores grid information of preset frontier points, including grid information of an initial node. The grid information includes position information and grid state information.

Step S13: On a half-line from the reference frontier point towards the first random node, the map region is searched for an exploration node that is one preset detection radius away from the reference frontier point, and then step S14 is performed. In step S13, taking the reference frontier point as a starting point, new nodes around the first random node that meet detection requirements of the frontier detector in the half-line direction pointing to the first random node are searched for and added to the random tree as new tree nodes of the random tree. The first random node may be surrounded by the map region pre-built by the robot or the unknown region. The reference frontier point belongs to the known map region pre-built by the robot, because the reference frontier point is a frontier point selected from the container and having known grid position information (marked grid information) within the map region.

Step S14: The frontier detector is controlled to check grids through which a line segment between the exploration node and the reference frontier point penetrates one by one, and then step S15 is performed to acquire the frontier points that meet the preset passing condition from the line segment. The map grids through which the line segment between the exploration node and the reference frontier point penetrates further include a grid corresponding to the exploration node and a grid corresponding to the reference frontier point. Compared with the prior art, in this embodiment, the robot may be controlled to explore the first random node in different directions as far as possible by means of the RRT algorithm, the reference frontier point near the first random node is searched for based on the node information pre-stored in the container, and then the exploration node scanned and detected with the reference frontier point as a center of a circle is acquired from the connecting line between the reference frontier point and the first random node, so that the frontier points that meet the preset passing condition on the connecting line between the exploration node and the reference frontier point are used for guiding the robot to preferentially explore a nearby region with the passing condition without constraints by an exploration direction.

Step S15: Whether a grid marked with an occupied state is detected out is determined. If yes, step S16 is performed, otherwise, step S17 is performed. The determining step is performed before an unknown grid is detected out, so as to preferentially remove a position of an obstacle, because the grid marked with the occupied state here represents a map region occupied by the obstacle. Of course, the determining step in step S15 may not be performed preferentially, as long as obstacles may be removed to determine the frontier points that meet the preset passing condition.

Step S16: The grid marked with the occupied state is not processed, and it is determined that the grid marked with the occupied state is not a frontier point that meets the preset passing condition. That is, the grid (which in fact is grid information of the grid) marked with the occupied state is neither stored into the container, nor stored into the filter. Then, step S11 is performed again to randomly generate a new first random node within the constructed map region. The filter is a functional module disposed inside the robot, including a software functional module, a hardware functional module, and/or a combination thereof for screening and filtering grid information. The filter is configured to check the exploration repeatability of the frontier points, and select from the frontier points stored in the frontier point list an actual position that is reachable for the robot to navigate to.

Step S17: Whether the grid marked with an unknown state is detected out is determined. If yes, step S18 is performed, otherwise, step S110 is performed. Of course, the step of determining an unknown grid region in step S17 may also be performed preferentially, as long as obstacles may be removed to determine the frontier points that meet the preset passing condition.

Step S18: Whether a grid marked with an occupied state exists in a circular region with the grid marked with the unknown state as a center of the circle and having a radius of one body passable distance. if yes, step S111 is performed, otherwise, step S19 is performed. Preferably, due to noise interference in a sensing range of a sensor, the body passable distance is set to be greater than a body width of the robot but smaller than twice the body width. The body passable distance is set to be 50 cm, which is greater than the body width of 30 cm but smaller than twice the body width of 60 cm. Thus, it is avoided that due to mis-determination of the grid marked with the occupied state within the circular region with the grid marked with the unknown state as the center of the circle and having the radius of one body passable distance by the sensor, the robot is guided to explore and collides with an obstacle.

Step S19: The grid marked with the unknown state is configured as the frontier point for exploring the unknown region by the robot, which indicates that the grid marked with the unknown state may allow the robot to traverse the navigation to explore the unknown environment region smoothly. The grid marked with the unknown state is determined as the frontier point marked with the unknown state that meets the preset passing condition. Meanwhile, the position information of the grid marked with the unknown state is added to the filter for further determination of repeated exploration, and then step S11 may be performed again until the number of grids added to the filter reaches a certain threshold. When external requirements for building of the global map or the local map of the robot are met, or step S3 is triggered externally to be performed, step S3 starts to be performed under a corresponding data signal condition, and the filter is called to process the added grid information to acquire the target point. In this process, the filtering action in step S2 may be synchronized with step S1.

Step S111: It is determined that the grid marked with the occupied state is not a frontier point that meets the preset passing condition, and the grid marked with the unknown state is not processed, that is, the position information of the grid marked with the unknown state is neither stored into the container, nor stored into the filter, and then step S11 is performed again. Therefore, in this embodiment, grids marked with the occupied state are preferentially removed from the line segment between the exploration node and the reference frontier point, then grids marked with the unknown state having obstacles within the body passable distance are removed, and grids marked with the unknown state having no obstacle within the body passable distance are retained and sent to the filter. Thus, the robot may acquire the frontier points marked with the unknown state that meet the preset passing condition, which is conducive to guiding the robot to explore the unknown region.

Step S110: It is determined that a grid marked with a free state is detected out, and then step S112 is performed. Because the map is represented by an occupied grid method in this embodiment, the grids are only marked with the three states: free, occupied, and unknown, according to different situations of each grid. Each of the frontier points has a corresponding grid, that is, on the map region (which is a grid map in this embodiment) built by the robot, each frontier point has a grid that matches a position thereof.

Step S112: Whether the grids through which the line segment between the exploration node and the reference frontier point penetrates detected by the frontier detector are all grids marked with the free state is determined. If yes, step S113 is performed, otherwise, step S11 is performed again. Of course, the step of determining a free grid region in step S112 may also be performed preferentially, as long as obstacles may be removed to determine the frontier points that meet the preset passing condition.

Step S113: All grids (which in fact are the grid information of the grids) marked with the free state except for the reference frontier point are stored into the container, all grids marked with the free state except for the reference frontier point are determined as frontier points marked with a free state that meet the preset passing condition, thereby obtaining grid information of newly set frontier points in the container, and step S11 is then performed again. The grids through which the line segment between the exploration node and the reference frontier point penetrates further include the grid corresponding to the exploration node and the grid corresponding to the reference frontier point. A frontier point that meets the preset passing condition may be searched for from the container as a new reference frontier point during the execution of step S12, so that the circular detection region of the frontier detector or the sensor formed with the reference frontier point as the center of the circle is kept away from obstacles.

In the above embodiments, the frontier detector includes a local detector and a global detector, so that the random tree constructed by the frontier detector includes a local random tree and a global random tree; and the preset detection radius includes a first preset detection radius and a second preset detection radius. The local detector is configured to explore frontier points within the first preset detection radius from the current position of the robot by constructing the local random tree, and to control the local random tree to reset whenever a grid marked with an unknown state is detected out. Preferably, the first preset detection radius is set to be 1 m, so that the frontier detector may explore details of near-range places more easily, for example, some corners. The global detector is configured to explore frontier points within the second preset detection radius from the current position of the robot by constructing the global random tree, but never control the global random tree to reset. Preferably, the second preset detection radius is set to be 10 m, so that the global detector may explore long-range places more easily. In this embodiment, the first preset detection radius is smaller than the second preset detection radius, and the first preset detection radius and the second preset detection radius are of different orders of magnitude, and both have an overlapping region with the sensing range of the sensor. When the local detector and the global detector perform the operation of checking the frontier points at the same time, the detection speed of the frontier points may be increased, and local maps generated by the local detector and the global detector respectively may be converted to a global map.

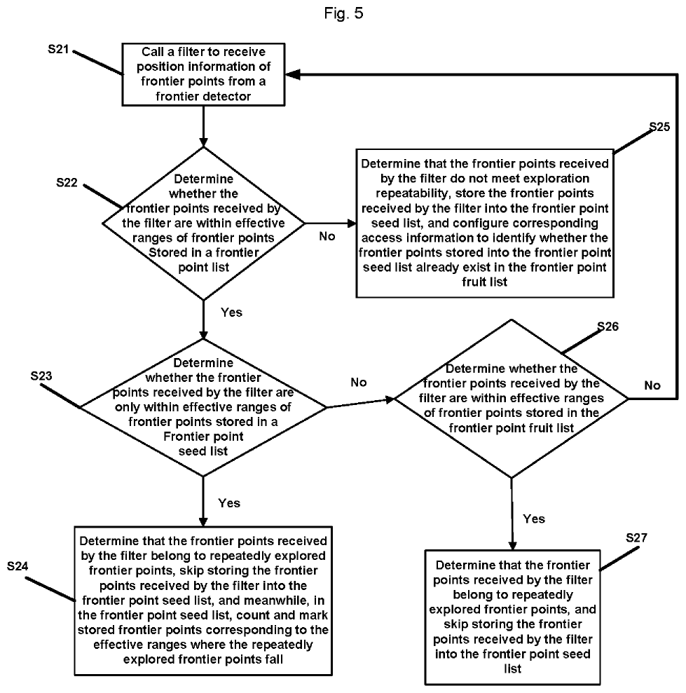

As an embodiment, as shown in FIG. 5, step S2 specifically includes: Step S21: The filter is called to receive the position information of the frontier points from the frontier detector, and step S22 is then performed. That is, the frontier points for exploring the unknown region by the robot among the frontier points acquired in step S1 that meet the preset passing condition are received.

Step S22: Whether the frontier points received by the filter are within effective ranges of the frontier points stored in the frontier point list is determined. If yes, step S23 is performed, otherwise, step S25 is performed. The frontier point list includes a frontier point seed list and a frontier point fruit list. Of course, the determining step is not necessarily performed preferentially, as long as frontier points that meet the exploration repeatability and the frontier points that do not meet the exploration repeatability may be distinguished and screened out, thereby avoiding repeated accesses to the same frontier point by the robot subsequently.

Step S25: It is determined that the frontier points received by the filter do not fall into the frontier point seed list or the frontier point fruit list, and do not meet the exploration repeatability, the frontier points received by the filter are stored into the frontier point seed list, and corresponding access information is configured to identify whether the frontier points stored into the frontier point seed list already exist in the frontier point fruit list. Specifically, when accessed and read by the frontier point fruit list, the access information of the frontier points stored into the frontier point seed list is configured as 1, otherwise, the access information of the frontier points stored into the frontier point seed list is configured as 0. Step S21 is then performed again, and the above steps are repeatedly performed, preferably, until step S3 starts to be performed under the triggering action of an external call.

Step S23: Whether the frontier points received by the filter are only within effective ranges of frontier points stored in the frontier point seed list. If yes, step S24 is performed, otherwise, step S26 is performed. The frontier points stored in the frontier point seed list are frontier points in the explored region of the robot, and are used as candidate target points for the robot to continue to explore the unknown region, which may be understood as nodes near a boundary between the unknown region and the known region. Of course, the determining step may also be performed preferentially, as long as the step may help distinguish and screen out the frontier points that meet the exploration repeatability and the frontier points that do not meet the exploration repeatability, thereby avoiding repeated accesses to the same frontier point by the robot subsequently.

Step S24: It is determined that the frontier points received by the filter belong to repeatedly explored frontier points, the frontier points received by the filter are not stored into the frontier point seed list, and meanwhile, in the frontier point seed list, stored frontier points corresponding to effective ranges of the repeatedly explored frontier points are counted and marked. Preferably, each time a frontier point received by the filter is detected to fall within an effective range of a known frontier point in the frontier point seed list, a matching count value of the known frontier point plus one for counting and marking, so that a frontier point with a corresponding count value being relatively great is preferentially assigned to the robot when configured as the target point in step S3.

Step S21 is then performed again, and the above steps are repeatedly performed until step S3 starts to be performed under the triggering action of an external call.

Step S26: Whether the frontier points received by the filter are within effective ranges of frontier points stored in the frontier point fruit list is determined. If yes, step S27 is performed, otherwise, step S21 is performed again until step S3 starts to be performed. Of course, the determining step may also be performed preferentially, as long as the step may help distinguish and screen out the frontier points that meet the exploration repeatability and the frontier points that do not meet the exploration repeatability, thereby avoiding repeated accesses to the same frontier point by the robot subsequently. The effective range of a frontier point stored in the frontier point list represents a circular region with the frontier point stored in the frontier point list as a center of the circle and having a first effective detection radius, and belongs to explored nodes of the robot. The first effective detection radius is preferably set to be 1.5 m, between the first preset detection radius and the second preset detection radius. With the existence of a frontier point stored in the frontier point list, it is sufficient to combine unknown regions in the circular region with the stored frontier point as the center of the circle and having the first effective detection radius into a known frontier point, so that all nodes within the effective range of the same frontier point have been represented by one frontier point.

Step S27: It is determined that the frontier points received by the filter belong to the repeatedly explored frontier points, the frontier points received by the filter are not stored into the frontier point seed list. Step S21 is then performed again, and the above steps are repeatedly performed until step S3 starts to be performed under the triggering action of an external call. Therefore, combined with the above steps, redundant frontier points may be filtered and regarded as explored frontier points, so that the amount of calculation is reduced, and the calculation time is shortened.

Preferably, step S3 starts to be performed if the number of frontier points stored in the frontier point seed list meets a certain threshold. The threshold here means that the number of the frontier points stored in the frontier point seed list is sufficient to meet map building navigation requirements of the robot for exploring local unknown regions, or may be a certain time interval, which indicates that every certain time interval or each time the count reaches a certain frontier point count threshold, step S2 is stopped and step S3 is performed.

In the above step, the filter is controlled to filter away the frontier points that may fall within detectable ranges of the frontier points stored in the frontier point list from the received frontier points, so that the repetition rate of frontier point exploration by the robot is reduced, and frontier points that are actually required to support the robot to explore the unknown region are acquired, so as to divide the map into the explored region of the robot and the unknown region. Since the filtering operation of the frontier points has been performed once, the number of frontier points stored in the frontier point seed list is constrained, and the phenomenon that the repetition rate of the target point is too high subsequently is avoided, which is conducive to reducing the amount of calculation and improving the exploration efficiency.

As an embodiment, step S3 specifically includes: when the target point is required to guide the robot to move to the unknown region, on the basis of the navigation costs of the frontier points and the income information corresponding to the navigation costs, and by considering the passable condition of the frontier points, the filter is controlled to select the frontier point with the highest revenue from the frontier points stored in the frontier point seed list, the frontier point is configured as the target point, and then the frontier point is stored into the frontier point fruit list. The frontier point seed list is continuously updated in steps S1 to S2, and the frontier point fruit list supports continuous updating in step S3. In this embodiment, few frontier points in the frontier point list are used as candidate target points to calculate and acquire the target point required by actual traversal of the robot, which saves amount of calculation and calculation time and reduces the exploration repetition rate of the target point compared with the prior art.

On the basis of the above embodiments, after the frontier point with the highest revenue is selected from the frontier points in the frontier point seed list, and added to the frontier point fruit list, based on a count value of the frontier points in the frontier point seed list obtained in step S24, a target point with the greatest count value is selected from target points with the same revenue stored in the frontier point fruit list, and is assigned to the robot, and then the robot is controlled to move from the current position to the target point with the greatest count value, thereby guiding the robot to build the local map within the unknown region. Thus, the robot is guided to explore a near unknown region without obstacles and build the local map, thereby meeting real-time requirements for the movement of the robot.

In step S3, the method for selecting the frontier point with the highest revenue from the frontier points stored in the frontier point seed list and adding the frontier point into the frontier point fruit list specifically includes: firstly, revenues of the frontier points stored in the frontier point seed list are calculated respectively, and then the revenues of the frontier points stored in the frontier point seed list are sorted by the numerical size. Sorting algorithms here include but are not limited to bubble sorting, quick sorting, heap sorting, simple selection sorting, Hill sorting, and direct insertion sorting.

Then, whether a grid marked with an occupied state exists within a circular region with a corresponding frontier point as a center of the circle and having the radius of one body passable distance is sequentially determined in an order of revenue from large to small. If yes, it is determined that the corresponding frontier point does not meet the passable condition, the corresponding frontier point is deleted from the frontier point seed list, and the determining step is repeatedly performed to determine whether a grid marked with an occupied state exists within a body passable distance of a frontier point with a second highest revenue. Otherwise, it is determined that the corresponding frontier point meets the passable condition, and meanwhile, the frontier point with the highest revenue (that is, the corresponding frontier point) is stored into the frontier point fruit list and configured as the target point. The body passable distance is preferably set to be 50 cm. In this embodiment, before output as the target point, another check for the grid marked with the occupied state is required, considering that there may be some frontier points in the frontier point seed list that have not been checked and screened by steps S1 to S2 above. Thus, the accuracy of obstacle avoidance of the robot is improved, and the robot is guided to explore a wider range of unknown region without obstacles.

Specifically, the method for calculating the revenues of the frontier points stored in the frontier point seed list includes: the revenue corresponding to each of the frontier points is equal to a difference obtained by subtracting the navigation cost from a product of an adjustable parameter and the income information, that is, R(x_{fp})=λI(x_{fp})−N(x_{fp}), where R(x_{fp}) denotes the revenue of each of the frontier points stored in the frontier point seed list, x_{fp} denotes a frontier point stored in the frontier point seed list; λ denotes the adjustable parameter, which is a positive constant parameter and is also an empirical value; I(x_{fp}) denotes the income information; and N(x_{fp}) denotes the navigation cost of the frontier point. λI(x_{fp}), as the product of the adjustable parameter and the income information, plays a role in adjusting the weight of the income information, and is used for making the robot explore a relatively large unknown region with a relatively small navigation cost by increasing the income information. The navigation cost of the frontier point is a straight-line distance between the current position of the robot and a frontier point currently involved in calculation stored in the frontier point seed list, expressed by a norm: N(x_{fp})=∥X_{cur}−X_{fp}|₂, which is specifically a straight-line distance between the current position point X_{cur} of the robot and the frontier point X_{fp} currently involved in the calculation stored in the frontier point seed list on the map region. Accordingly, the income information I(x_{fp}) is an area of an unknown region in a circle with the frontier point currently involved in the calculation stored in the frontier point seed list and having a second effective detection radius. It is to be noted that I(x_{fp}) is equal to an area of the circle with the frontier point as the center of the circle and having the second effective detection radius minus an area of an explored grid region of the circle marked on the map. The second effective detection radius is smaller than or equal to the sensing radius of the sensor used by the robot to scan the environment, and the second effective detection radius is equal to the sensing radius of the sensor used by the robot to scan the environment in a conventional scanning environment. In this embodiment, the setting of the adjustable weight is conducive to controlling the robot to prefer exploring a larger unknown region with a minimal navigation cost, thereby reducing the calculation load of a robot system.

As an embodiment, in a map region shown in FIG. 1a, the robot performs steps S1 to S3 of the above embodiments from an initial position within a known map region (a pre-built white map region) to explore a frontier point A and expand to explore a new white known map region by using the frontier detector and the filter, where the frontier point A is configured as the target point, and then the robot is controlled to move from the initial position to the frontier point A, as shown in FIG. 1b. In FIG. 1b, after exploring and navigating to the frontier point A, the robot performs steps S1 to S3 of the above embodiments at the frontier point A to expand a larger range of known region on the basis of the known region shown in FIG. 1a, acquires new black solid circles shown in FIG. 1b as the frontier points to be stored into the frontier point seed list, and then calculates and screens out the frontier point with the highest revenue from the frontier points as the target point for guiding the robot to navigate to the unknown region. Then, combined with FIG. 2a, it may be seen that a frontier point B is selected as the frontier point with the highest revenue value in FIG. 1b, so that the robot moves from the frontier point A in FIG. 1b to the frontier point B in FIG. 2a. It is to be noted that map regions in FIG. 1 and FIG. 2 represent maps within the same working region.

Then, by performing steps S1 to S3 of the above embodiments, the robot acquires a frontier point D, a frontier point C and other frontier points configured to be added to the frontier point seed list at the frontier point B in FIG. 2a. Combined with FIG. 2b, it may be seen that the robot takes the frontier point C as the target point acquired by calculation in the map region in FIG. 2a, and the robot is then controlled to move from the frontier point B to the frontier point C, thereby forming FIG. 2b.

In FIG. 2b, the robot performs steps S1 to S3 of the above embodiments at the frontier point C. Since the robot is almost surrounded by walls of a room in three axis directions at the frontier point C, and the robot detects out that obstacles exist within a body passable distance of the frontier point within a room region to which the current position belongs, the frontier points that meet the preset passing condition fail to be explored. Therefore, the robot fails to explore new frontier points that may be added to the frontier point seed list (no new candidate target points are added), as shown by the black solid circles distributed in FIG. 2b. Of course, the explored region (the built white map region as shown) of the robot is larger than that in FIG. 2a. Therefore, according to a calculation result of revenues of frontier points corresponding to the black solid circles shown in the figure, the robot is controlled to move from the frontier point C to the frontier point D with the highest revenue within the white region in FIG. 2b.

At the frontier point D in FIG. 2c, the robot is not surrounded by walls on three sides as in FIG. 2b, and detects out that no obstacle exists within the body passable distance of the frontier point, and a sensing angle of the sensor of the robot is wider than that of FIG. 2b, so that the robot may acquire new frontier points that may be added to the frontier point seed list by performing steps S1 to S3 of the above embodiments, as shown by newly added black solid circles in three directions in the upper part of FIG. 2c. In this case, the known map region built by the robot is also expanded.

In summary, the robot iteratively performs steps S1 to S4 of the above embodiments until local maps built by the robot at different frontier points are combined into a complete global map to completely cover the illustrated working region. It is to be noted that the direction of exploration and movement of the robot tends to a larger unknown region (a slash-filled region shown in the figures) and tends to frontier points with smaller navigation costs (the solid black circles shown in the figures).

A chip is provided. The chip is configured to store a program. The program is configured to perform the map exploration method for exploring the unknown region by the robot. The amount of calculation of exploration for frontier points is reduced, and the exploration efficiency is improved.

A robot is provided. A sensor for scanning an environment is assembled on a body surface of the robot. The chip is disposed inside the robot and configured to perform the map exploration method for exploring the unknown region by the robot. The obstacle avoidance capacity of the robot during exploring an unknown environment is enhanced, and the number of times of repeated exploration for frontier points by the robot is also effectively reduced. In this embodiment, the sensor used for scanning the environment is a laser radar sensor that supports 360-degree rotational scanning.

Those skilled in the art will appreciate that the embodiments of the present application may be provided as methods, systems, or computer program products. Therefore, the present application may take the form of a full hardware embodiment, a full software embodiment, or an embodiment combining software and hardware. Besides, the present application may adopt the form of a computer program product implemented on one or more computer available storage media (including but not limited to a disk memory, a CD-ROM, an optical memory and the like) including computer available program codes.

The present application is described with reference to the flow diagram and/or block diagram of the method, device (system), and computer program product according to the embodiments of the present application. It should be understood that each flow and/or block in the flow diagram and/or block diagram and the combination of flows and/or blocks in the flow diagram and/or block diagram can be implemented by computer program instructions. These computer program instructions may be provided to processors of a general-purpose computer, a special-purpose computer, an embedded processor or other programmable data processing devices to generate a machine, such that instructions executed by processors of a computer or other programmable data processing devices generate an apparatus for implementing the functions specified in one or more flows of the flow diagram and/or one or more blocks of the block diagram.

These computer program instructions may also be stored in a computer-readable memory capable of guiding a computer or other programmable data processing devices to work in a specific manner, such that instructions stored in the computer-readable memory generate a manufactured product including an instruction apparatus, and the instruction apparatus implements the functions specified in one or more flows of the flow diagram and/or one or more blocks of the block diagram.

These computer program instructions may also be loaded on a computer or other programmable data processing devices, so that a series of operation steps are executed on the computer or other programmable devices to produce computer-implemented processing, and thus, the instructions executed on the computer or other programmable devices provide steps for implementing the functions specified in one or more flows of the flow diagram and/or one or more blocks of the block diagram.

The above are only preferred embodiments of the present disclosure, and are intended to limit the present disclosure in any other form. Any person skilled in the art may use the technical content disclosed above to alter or modify it as an equivalent embodiment of the equivalent change.

However, any simple modification, equivalent change or transformation of the above embodiments based on the technical substance of the present disclosure without departing from the content of the technical solutions of the present disclosure still belongs to the scope of protection of the technical solutions of the present disclosure.

1. A map exploration method for exploring an unknown region by a robot, comprising:
step 1: acquiring frontier points that meet a preset passing condition by means of a frontier detector based on a rapid exploration random tree algorithm;
step 2: checking exploration repeatability of frontier points for exploring the unknown region by the robot among the frontier points acquired in step 1, and storing frontier points that do not meet the exploration repeatability into a frontier point list according to a check result; and
step 3: on the basis of navigation costs of the frontier points and income information corresponding to the navigation costs, and by considering a passable condition of the frontier points, selecting a frontier point with the highest revenue from the frontier points stored in the frontier point list, configuring the frontier point as a target point, and then controlling the robot to move from a current position to the target point, thereby guiding the robot to build a map within the unknown region.

2. The map exploration method according to claim 1, wherein the step 1 comprises:
step 11: randomly exploring a first random node within a pre-built map region based on a random tree constructed by the frontier detector, and then proceeding to step 12;
step 12: searching position information of frontier points pre-stored in a container for a frontier point closest to the first random node within the map region, configuring the frontier point as a reference frontier point, and then proceeding to step 13, wherein the container is a memory space set up within the robot to support continuous storage of data information, the container stores grid information of preset frontier points, and the grid information comprises the position information and grid state information;
step 13: on a half-line from the reference frontier point towards the first random node, searching the map region for an exploration node that is one preset detection radius away from the reference frontier point, and then proceeding to step 14, wherein the preset detection radius is detection distance information configured by the frontier detector; and
step 14: controlling the frontier detector to check a line segment between the exploration node and the reference frontier point and acquire the frontier points that meet the preset passing condition.

3. The map exploration method according to claim 2, wherein checking the line segment between the exploration node and the reference frontier point and acquiring the frontier points that meet the preset passing condition comprises:
under the condition that the frontier detector checks that grids through which the line segment between the exploration node and the reference frontier point penetrates are all grids marked with a free state, storing all grids marked with the free state on the line segment except for the reference frontier point into the container, and determining all grids marked with the free state on the line segment except for the reference frontier point as frontier points marked with a free state that meet the preset passing condition, thereby obtaining grid information of newly set frontier points in the container,
wherein the grids through which the line segment between the exploration node and the reference frontier point penetrates further comprise a grid corresponding to the exploration node and a grid corresponding to the reference frontier point; and
wherein each of the frontier points has a corresponding grid.

4. The map exploration method according to claim 2, wherein checking the line segment between the exploration node and the reference frontier point and acquiring the frontier points that meet the preset passing condition further comprises:
in a process that the frontier detector checks grids through which the line segment between the exploration node and the reference frontier point penetrates one by one, under the condition that a grid marked with an occupied state is detected out, skipping processing the grid marked with the occupied state and then returning to step 11;
under the condition that a grid marked with an unknown state is detected out, continuing to check whether a grid marked with an occupied state exists within a circular region with the grid marked with the unknown state as a center of the circle and having a radius of one body passable distance; if the grid marked with the occupied state exists within the circular region, skipping processing the grid marked with the unknown state and then returning to step 11; if the grid marked with the occupied state does not exist within the circular region, configuring the grid marked with the unknown state as a frontier point for exploring the unknown region by the robot, determining the grid marked with the unknown state as a frontier point marked with an unknown state that meets the preset passing condition, and meanwhile, adding the grid marked with the unknown state into the filter, wherein the body passable distance is set to be greater than a body width of the robot but smaller than twice the body width; and
wherein the filter is a functional module disposed inside the robot for checking the exploration repeatability of the frontier points and selecting, from the frontier points stored in the frontier point list, an actual position that is reachable for the robot to navigate to.

5. The map exploration method according to claim 3, wherein the frontier detector comprises a local detector and a global detector, so that the random tree constructed by the frontier detector comprises a local random tree and a global random tree; and the preset detection radius comprises a first preset detection radius and a second preset detection radius,
wherein the local detector is configured to explore frontier points within the first preset detection radius from the current position of the robot by constructing the local random tree, and to control the local random tree to reset whenever a grid marked with an unknown state is detected out;
the global detector is configured to explore frontier points within the second preset detection radius from the current position of the robot by constructing the global random tree, but never control the global random tree to reset; and
the first preset detection radius is smaller than the second preset detection radius, and the first preset detection radius and the second preset detection radius are of different orders of magnitude.

6. The map exploration method according to claim 5, wherein the step 2 comprises:
under the condition that frontier points received by the filter are only within effective ranges of frontier points stored in a frontier point seed list, determining that the frontier points received by the filter are repeatedly explored frontier points, skipping storing the frontier points received by the filter into the frontier point seed list, and meanwhile, in the frontier point seed list, counting and marking stored frontier points corresponding to the effective ranges until step 3 starts to be performed, wherein each of the frontier points stored in the frontier point seed list has a matching effective range to represent an explored region of the robot;
under the condition that the frontier points received by the filter are within effective ranges of frontier points stored in a frontier point fruit list, determining that the frontier points received by the filter are repeatedly explored frontier points, and skipping storing the frontier points received by the filter into the frontier point seed list; and
under the condition that the frontier points received by the filter are not within the effective ranges of the frontier points stored in the frontier point list, determining that the frontier points received by the filter do not meet the exploration repeatability, and storing the frontier points received by the filter into the frontier point seed list until step 3 starts to be performed,
wherein the effective range of each of the frontier points stored in the frontier point list represents a circular region with the frontier point stored in the frontier point list as a center of the circle and having a first effective detection radius, and belongs to explored nodes of the robot; the first effective detection radius is smaller than a sensing radius of a sensor used by the robot to scan an environment, the first effective detection radius is greater than the first preset detection radius, and the first effective detection radius is smaller than the second preset detection radius; and
wherein the frontier point list comprises the frontier point seed list and the frontier point fruit list.

7. The map exploration method according to claim 6, wherein the step 3 comprises:
on the basis of the navigation costs of the frontier points and the income information corresponding to the navigation costs, and by considering the passable condition of the frontier points, controlling the filter to select the frontier point with the highest revenue from the frontier points stored in the frontier point seed list, configuring the frontier point as the target point, and then storing the frontier point into the frontier point fruit list.

8. The map exploration method according to claim 7, wherein the step 3 further comprises:
after selecting the frontier point with the highest revenue from the frontier points in the frontier point seed list and adding the frontier point into the frontier point fruit list, based on a count value of the frontier points in the frontier point seed list obtained in step 2, selecting a target point with the greatest count value from target points with the same revenue stored in the frontier point fruit list, assigning the target point to the robot, and then controlling the robot to move from the current position to the target point with the greatest count value, thereby guiding the robot to build a local map within the unknown region.

9. The map exploration method according to claim 8, wherein in the step 3, a method for selecting the frontier point with the highest revenue from the frontier points stored into the frontier point seed list and adding the frontier point into the frontier point fruit list comprises:
calculating revenues of the frontier points stored in the frontier point seed list respectively, and then sorting the revenues of the frontier points stored in the frontier point seed list by numerical size;
sequentially determining, in an order of revenue from large to small, whether a grid marked with an occupied state exists within the circular region with the corresponding frontier point as a center of the circle and having the radius of one body passable distance; if the grid marked with the occupied state exists within the circular region, determining that the corresponding frontier point does not meet the passable condition, deleting the corresponding frontier point from the frontier point seed list, and repeatedly performing the determining step to determine a frontier point with a second greatest revenue; if the grid marked with the occupied state does not exist within the circular region, determining that the corresponding frontier point meets the passable condition, meanwhile, storing the corresponding frontier point into the frontier point fruit list, and configuring the frontier point as the target point.

10. The map exploration method according to claim 9, wherein a method for calculating the revenues of the frontier points stored in the frontier point seed list comprises:
the revenue corresponding to each of the frontier points stored in the frontier point seed list is equal to a difference obtained by subtracting the navigation cost from a product of an adjustable parameter and the income information,
wherein the adjustable parameter is a positive constant parameter; and
wherein the navigation cost is a straight-line distance between the current position of the robot and one frontier point currently involved in calculation stored in the frontier point seed list; accordingly, the income information is an area of an unknown region in a circle with the frontier point currently involved in the calculation stored in the frontier point seed list as a center of the circle and having a second effective detection radius; and the second effective detection radius is smaller than or equal to the sensing radius of the sensor used by the robot to scan the environment.

11. A chip, configured to store a program, wherein the program is configured to implement;
step 1: acquiring frontier points that meet a preset passing condition by means of a frontier detector based on a rapid exploration random tree algorithm;
step 2: checking exploration repeatability of frontier points for exploring the unknown region by the robot among the frontier points acquired in step 1, and storing frontier points that do not meet the exploration repeatability into a frontier point list according to a check result; and
step 3: on the basis of navigation costs of the frontier points and income information corresponding to the navigation costs, and by considering a passable condition of the frontier points, selecting a frontier point with the highest revenue from the frontier points stored in the frontier point list, configuring the frontier point as a target point, and then controlling the robot to move from a current position to the target point, thereby guiding the robot to build a map within the unknown region.

12. A robot provided with a sensor for scanning an environment on a body surface, wherein a chip is disposed inside the robot, and configured to perform:
step 1: acquiring frontier points that meet a preset passing condition by means of a frontier detector based on a rapid exploration random tree algorithm;
step 2: checking exploration repeatability of frontier points for exploring the unknown region by the robot among the frontier points acquired in step 1, and storing frontier points that do not meet the exploration repeatability into a frontier point list according to a check result; and
step 3: on the basis of navigation costs of the frontier points and income information corresponding to the navigation costs, and by considering a passable condition of the frontier points, selecting a frontier point with the highest revenue from the frontier points stored in the frontier point list, configuring the frontier point as a target point, and then controlling the robot to move from a current position to the target point, thereby guiding the robot to build a map within the unknown region.

13. The map exploration method according to claim 4, wherein the frontier detector comprises a local detector and a global detector, so that the random tree constructed by the frontier detector comprises a local random tree and a global random tree; and the preset detection radius comprises a first preset detection radius and a second preset detection radius, wherein the local detector is configured to explore frontier points within the first preset detection radius from the current position of the robot by constructing the local random tree, and to control the local random tree to reset whenever a grid marked with an unknown state is detected out:
the global detector is configured to explore frontier points within the second preset detection radius from the current position of the robot by constructing the global random tree, but never control the global random tree to reset; and
the first preset detection radius is smaller than the second preset detection radius, and the first preset detection radius and the second preset detection radius are of different orders of magnitude.

14. The chip according to claim 11, wherein the step 1 comprises:
step 11: randomly exploring a first random node within a pre-built map region based on a random tree constructed by the frontier detector, and then proceeding to step 12;
step 12: searching position information of frontier points pre-stored in a container for a frontier point closest to the first random node within the map region, configuring the frontier point as a reference frontier point, and then proceeding to step 13, wherein the container is a memory space set up within the robot to support continuous storage of data information, the container stores grid information of preset frontier points, and the grid information comprises the position information and grid state information;
step 13: on a half-line from the reference frontier point towards the first random node, searching the map region for an exploration node that is one preset detection radius away from the reference frontier point, and then proceeding to step 14, wherein the preset detection radius is detection distance information configured by the frontier detector; and
step 14: controlling the frontier detector to check a line segment between the exploration node and the reference frontier point and acquire the frontier points that meet the preset passing condition.

15. The chip according to claim 14, wherein checking the line segment between the exploration node and the reference frontier point and acquiring the frontier points that meet the preset passing condition comprises:
under the condition that the frontier detector checks that grids through which the line segment between the exploration node and the reference frontier point penetrates are all grids marked with a free state, storing all grids marked with the free state on the line segment except for the reference frontier point into the container, and determining all grids marked with the free state on the line segment except for the reference frontier point as frontier points marked with a free state that meet the preset passing condition, thereby obtaining grid information of newly set frontier points in the container,
wherein the grids through which the line segment between the exploration node and the reference frontier point penetrates further comprise a grid corresponding to the exploration node and a grid corresponding to the reference frontier point; and
wherein each of the frontier points has a corresponding grid.

16. The chip according to claim 14, wherein checking the line segment between the exploration node and the reference frontier point and acquiring the frontier points that meet the preset passing condition further comprises:
in a process that the frontier detector checks grids through which the line segment between the exploration node and the reference frontier point penetrates one by one, under the condition that a grid marked with an occupied state is detected out, skipping processing the grid marked with the occupied state and then returning to step 11;
under the condition that a grid marked with an unknown state is detected out, continuing to check whether a grid marked with an occupied state exists within a circular region with the grid marked with the unknown state as a center of the circle and having a radius of one body passable distance; if the grid marked with the occupied state exists within the circular region, skipping processing the grid marked with the unknown state and then returning to step 11; if the grid marked with the occupied state does not exist within the circular region, configuring the grid marked with the unknown state as a frontier point for exploring the unknown region by the robot, determining the grid marked with the unknown state as a frontier point marked with an unknown state that meets the preset passing condition, and meanwhile, adding the grid marked with the unknown state into the filter, wherein the body passable distance is set to be greater than a body width of the robot but smaller than twice the body width; and
wherein the filter is a functional module disposed inside the robot for checking the exploration repeatability of the frontier points and selecting, from the frontier points stored in the frontier point list, an actual position that is reachable for the robot to navigate to.

17. The chip according to claim 15, wherein the frontier detector comprises a local detector and a global detector, so that the random tree constructed by the frontier detector comprises a local random tree and a global random tree; and the preset detection radius comprises a first preset detection radius and a second preset detection radius,
wherein the local detector is configured to explore frontier points within the first preset detection radius from the current position of the robot by constructing the local random tree, and to control the local random tree to reset whenever a grid marked with an unknown state is detected out;
the global detector is configured to explore frontier points within the second preset detection radius from the current position of the robot by constructing the global random tree, but never control the global random tree to reset; and
the first preset detection radius is smaller than the second preset detection radius, and the first preset detection radius and the second preset detection radius are of different orders of magnitude.

18. The chip according to claim 17, wherein the step 2 comprises:
under the condition that frontier points received by the filter are only within effective ranges of frontier points stored in a frontier point seed list, determining that the frontier points received by the filter are repeatedly explored frontier points, skipping storing the frontier points received by the filter into the frontier point seed list, and meanwhile, in the frontier point seed list, counting and marking stored frontier points corresponding to the effective ranges until step 3 starts to be performed, wherein each of the frontier points stored in the frontier point seed list has a matching effective range to represent an explored region of the robot;
under the condition that the frontier points received by the filter are within effective ranges of frontier points stored in a frontier point fruit list, determining that the frontier points received by the filter are repeatedly explored frontier points, and skipping storing the frontier points received by the filter into the frontier point seed list; and
under the condition that the frontier points received by the filter are not within the effective ranges of the frontier points stored in the frontier point list, determining that the frontier points received by the filter do not meet the exploration repeatability, and storing the frontier points received by the filter into the frontier point seed list until step 3 starts to be performed,
wherein the effective range of each of the frontier points stored in the frontier point list represents a circular region with the frontier point stored in the frontier point list as a center of the circle and having a first effective detection radius, and belongs to explored nodes of the robot; the first effective detection radius is smaller than a sensing radius of a sensor used by the robot to scan an environment, the first effective detection radius is greater than the first preset detection radius, and the first effective detection radius is smaller than the second preset detection radius; and
wherein the frontier point list comprises the frontier point seed list and the frontier point fruit list.

19. The chip according to claim 18, wherein the step 3 comprises:
on the basis of the navigation costs of the frontier points and the income information corresponding to the navigation costs, and by considering the passable condition of the frontier points, controlling the filter to select the frontier point with the highest revenue from the frontier points stored in the frontier point seed list, configuring the frontier point as the target point, and then storing the frontier point into the frontier point fruit list.

20. The chip according to claim 19, wherein the step 3 further comprises:
after selecting the frontier point with the highest revenue from the frontier points in the frontier point seed list and adding the frontier point into the frontier point fruit list, based on a count value of the frontier points in the frontier point seed list obtained in step 2, selecting a target point with the greatest count value from target points with the same revenue stored in the frontier point fruit list, assigning the target point to the robot, and then controlling the robot to move from the current position to the target point with the greatest count value, thereby guiding the robot to build a local map within the unknown region.
